(19) United States
(12) Patent Application Publication
(10) Pub. No.: US 2012/0146469 A1
(43) Pub. Date: Jun. 14, 2012

(54) COMPUTER CASE

(75) Inventors: JUN-XIONG ZHANG, Shenzhen City (CN); YOU-TAO WANG, Shenzhen City (CN); DE-HUA TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/011,790

(22) Filed: Jan. 21, 2011

(30) Foreign Application Priority Data
Dec. 9, 2010 (CN) 201010580859.6

(51) Int. Cl. G06F 1/18

(52) U.S. Cl. 312/223.2

(57) ABSTRACT

A computer case includes two opposite boards, two brackets, two elastic elements, and two latching elements. Each board has a recessed portion with a resisting surface. The two brackets are rotatably connected to the two resisting surfaces respectively. Each bracket defines a pinhole away from the resisting surface. Each elastic element is positioned between a corresponding resisting surface and a corresponding bracket to supply elastic force between the corresponding resisting surface and the corresponding bracket. The two latching elements are slidably mounted on the two opposite boards. Each latching element includes a latching portion. When the brackets contact the resisting surfaces, the latching portions are received in the pinholes to latch the brackets.

### BACKGROUND

1. Technical Field

The present disclosure relates to a computer case.

2. Description of Related Art

A computer case can be used for a rack server or a tower server. When used for a rack server, the computer case is fixed on a rack by two L-shaped fixing brackets on two opposite boards of the computer case. When used for a standalone tower server, one of the two opposite boards acts as a bottom. The L-shaped fixing brackets must be removed from the computer case to ensure that the computer case can stand securely. Yet, to remove the L-shaped fixing brackets is time consuming and the removed L-shaped fixing brackets are easily lost.

What is needed, therefore, is a computer case to overcome the described limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 is a schematic assembled view of a computer case according to an exemplary embodiment.

FIG. 2 is a partially exploded view of the computer case of FIG. 1.

FIG. 3 is a schematic view of the computer case of FIG. 1 used as a tower server.

FIG. 4 is a schematic view of a latched fixing bracket of the computer case of FIG. 1.

FIG. 5 is a schematic view of the computer case of FIG. 1 used as a rack server.

### DETAILED DESCRIPTION

Embodiments of the present disclosure are described here in detail, with reference to the accompanying drawings.

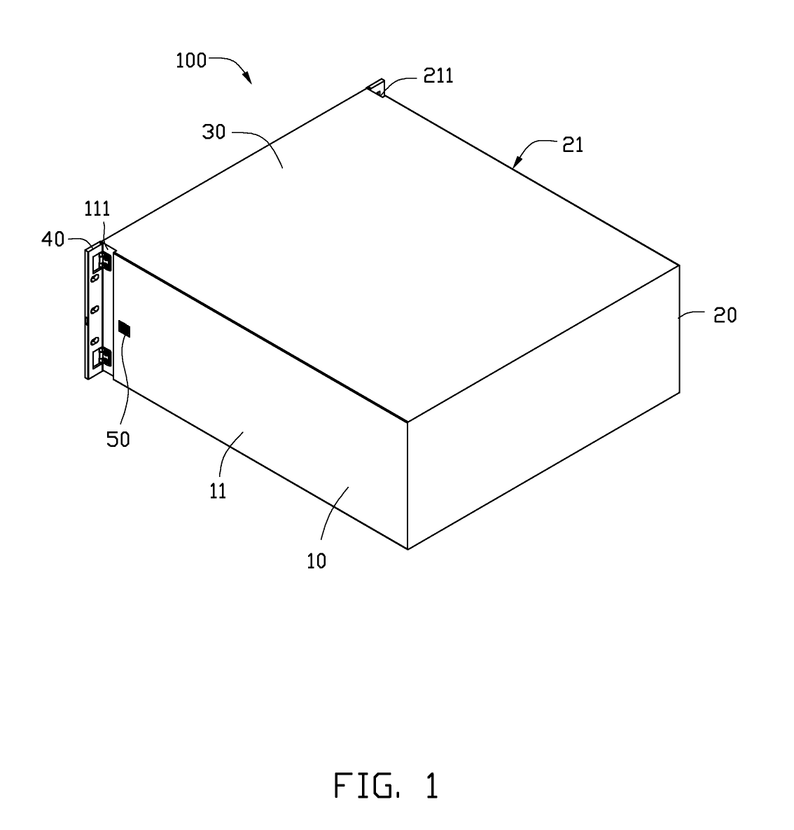

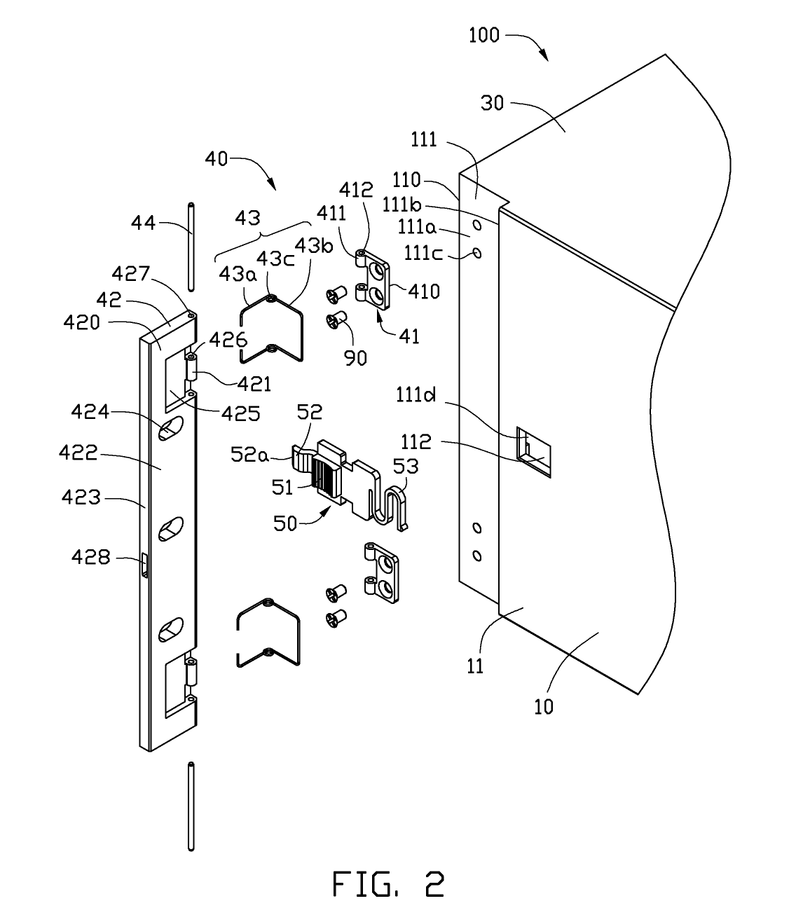

Referring to FIGS. 1-2, a computer case 100 according to an exemplary embodiment is shown. The computer case 100 includes a first board 10, a second board 20, four sideboards 30, two connection assemblies 40, and two latching elements 50. The first board 10 and the second board 20 are opposite and rectangular boards. The four sideboards 30 are connecting the first board 10 and the second board 20. The first board 10, the second board 20, and the four sideboards 30 are joined together to form a cuboid.

The first board 10 includes a first surface 11 away from the second board 20. The first surface 11 includes a first recessed portion 111 and an edge 110. The first recessed portion 111 is a stepped structure adjacent to the edge 110. The first recessed portion 111 includes a resisting surface 111a and a connecting surface 111b. The resisting surface 111a is parallel to the first surface 11. Four threaded holes 111c are defined in the resisting surface 111a along the edge 110. The connecting surface 111b connects the first surface 11 and the resisting surface 111a, and is perpendicular thereto. The first surface 11 defines a receiving groove 112 receiving the latching element 50. The connecting surface 111b defines a through hole 111d communicating with the receiving groove 112.

One connection assembly 40 is fixed on the resisting surface 111a. Each connection assembly 40 includes two connecting elements 41, a bracket 42, two elastic elements 43, and two shafts 44. The thickness of the bracket 42 is less than or equal to the height of the connecting surface 111b perpendicular to the resisting surface 111a. The connecting elements 41 are fixed on the resisting surface 111a, and rotatably connected to the bracket 42. One end of each elastic element 43 resists the resisting surface 111a, and the other end resists the bracket 42 to apply elastic force between the resisting surface 111a and the bracket 42. In the present embodiment, the connecting element 41 is a rectangular sheet structure. Each connecting element 41 includes a first body 410 and two first connection portions 411 arrayed at one edge of the first body 410. The first body 410 is fixed on the resisting surface 111a by fasteners 90. Each first connection portion 411 defines a first connection hole 412.

The bracket 42 includes a second body 420 and two second connection portions 421 arrayed at one edge of the second body 420. The second body 420 is a rectangular sheet structure. The second body 420 includes a first bracket surface 422 and a first bracket sidewall 423 perpendicular to the first bracket surface 422. Three fixing through holes 424 and two grooves 425 are respectively defined in the first bracket surface 422. The second connection portion 421 is positioned on a side of the groove 425. Each second connection portion 421 defines a second connection hole 426. The bracket 42 defines three shaft holes 427 coaxial to the second connection hole 426. The first connection portion 411 is rotatably connected to the second connection portion 421 by the shaft 44 received in the shaft holes 427, the first connection holes 412, and the second connection holes 426. When the bracket 42 abuts the connecting elements 41, the connecting elements 41 are received in the grooves 425. A pinhole 428 is defined in the first bracket sidewall 423 away from the second connection portion 421.

The elastic elements 43 are torsion springs. Each of the elastic elements 43 includes a first resisting end 43a, a second resisting end 43b, and a hinge portion 43c connecting the first resisting end 43a and the second resisting end 43b. In the present embodiment, the hinge portion 43c is coiled around the shaft 44. The first resisting end 43a is received in the groove 425, and resists the bracket 42. The second resisting end 43b is a rectangular frame coiled around the connecting element 41, and resisting the resisting surface 111a.

The second board 20 includes a second surface 21 away from the first board 10. A second recessed portion 211 is formed on the second surface 21 corresponding to the first recessed portion 111. The configuration of the second recessed portion 211 is the same as the first recessed portion 111. The other connection assembly 40 is mounted on the second recessed portion 211.

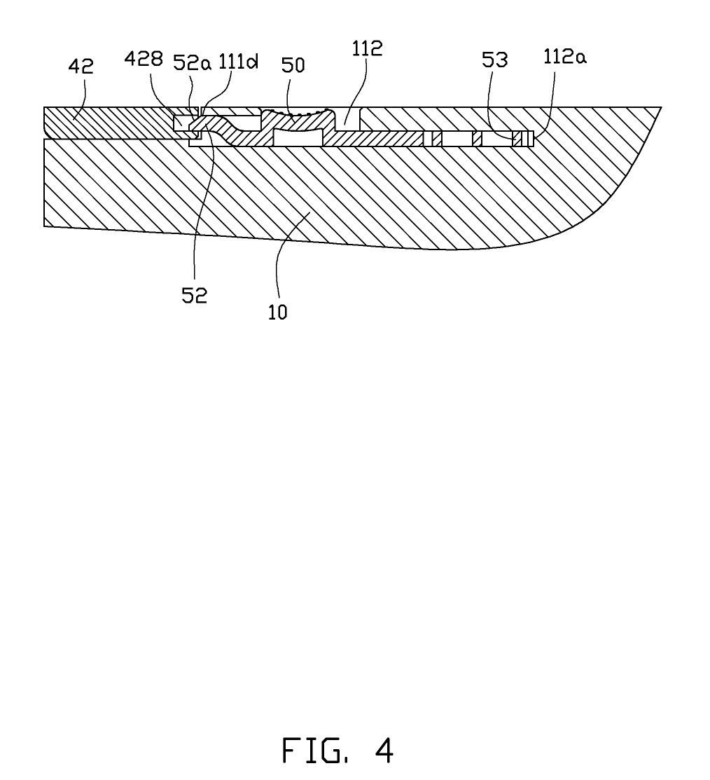

The two latching elements 50 are slidable relative to the first board 10 and the second board 20 respectively. In the present embodiment, the latching elements 50 are plastic. The latching elements 50 are buttons and are slidably received in the receiving grooves 112. Each of the latching elements 50 includes a contact portion 51, a latching portion 52, and a flexible portion 53. The contact portion 51 connects the latching portion 52 and the flexible portion 53. A wedge surface 52a is formed on the latching portion 52. The flexible portion 53 is S-shaped. Referring to FIG. 4, the flexible portion 53 resists the inner sidewall 112a of the receiving groove 112. The flexible portion 53 impels the latching portion 52 out of the connecting surface 111b from the through hole 111d. When the bracket 42 abuts the connecting elements 41, the latching portion 52 is received in the pinhole 428 of the bracket 42 to latch the bracket 42. The contact portion 51 receives pressure to drive the element 50 away from the bracket 42 to withdraw the latching portion 52 from the pinhole 428.

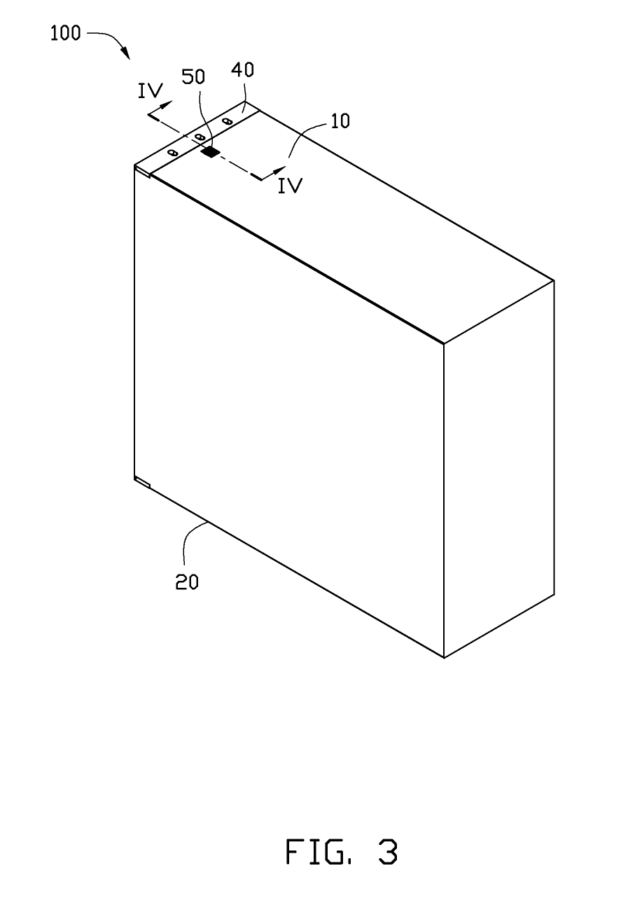

Referring to FIGS. 2 and 3, when the computer case 100 is used as a tower server, the brackets 42 are rotated to and resist the resisting surfaces 111a, at which time the latching portions 52 are received in the pinholes 428 to latch the brackets 42. Thus, the brackets 42 are fully received in the first recessed portion 111 and the second recessed portion 211. The computer case 100 can stand securely with no requirement to remove the brackets 42.

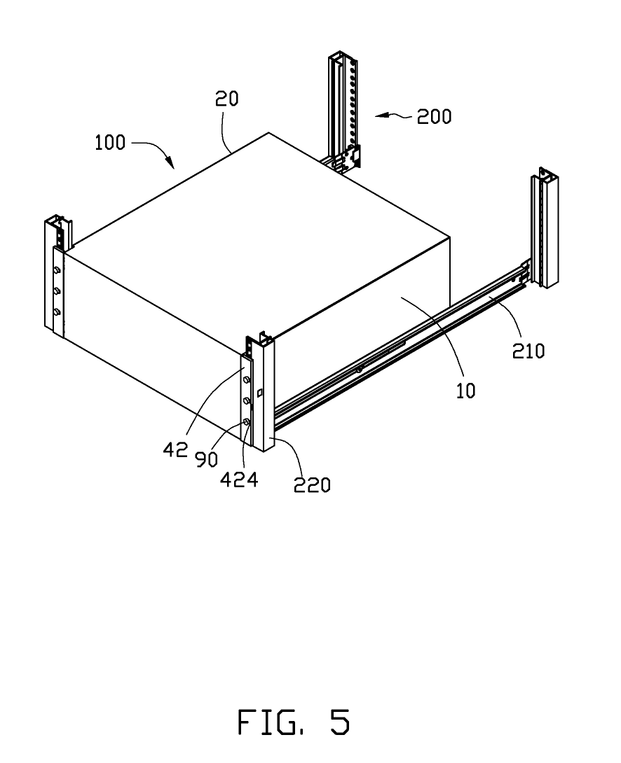

Referring to FIGS. 2 and 5, when the computer case 100 is used as a rack server, the latching portions 52 are withdrawn from the pinholes 428 to release the brackets 42. The brackets 42 are rotated away from the resisting surfaces 111a by the elastic elements 43. The computer case 100 is seated on the sliding rails 210 of a rectangular rack 200 and fixed thereto by the fasteners 90 extending through the fixing through holes 424 into the threaded holes (not shown) defined in the rectangular rack 200.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A computer case comprising:
two opposite boards, each board having a recessed portion with a resisting surface;
two brackets rotatably connected to the two resisting surfaces respectively, each bracket defining a pinhole;
two elastic elements, each elastic element positioned between a corresponding resisting surface and a corresponding bracket for applying an elastic force between the corresponding resisting surface and the corresponding bracket; and
two latching elements slidably mounted on the two opposite boards, each latching element comprising a latching portion;
wherein when the brackets contact the resisting surfaces, the latching portions are capable of being received in the pinholes to latch the brackets.

2. The computer case as claimed in claim 1, wherein each of the two recessed portions is a stepped structure formed on one edge of each board and comprises a connecting surface, the connecting surface connects to the resisting surface.

3. The computer case as claimed in claim 2, wherein each board defines a receiving groove, each recessed portion defines a through hole in the connecting surface thereof, the through hole is communicated with the receiving groove of a corresponding board, each latching element is received in the receiving groove and capable of extending out of the connecting surface through the through hole to be received in the pinhole.

4. The computer case as claimed in claim 3, wherein each of the latching elements further comprises a contact portion and a flexible portion, the contact portion is connected between the latching portion and the flexible portion, the contact portion is exposed through the receiving groove, the flexible portion resists against an inner sidewall of the receiving groove.

5. The computer case as claimed in claim 4, wherein the flexible portion is S-shaped.

6. The computer case as claimed in claim 1, wherein the elastic elements are torsion springs, each elastic element comprises a first resisting end resisting against the corresponding bracket, a second resisting end resisting against the corresponding resisting surface, and a hinge portion connecting the first resisting end and the second resisting end.

7. The computer case as claimed in claim 1, further comprising four connecting elements fixed on the resisting surface, wherein each bracket defines two grooves for receiving two of the connecting elements, the bracket is rotatably connected to the two connecting elements.

8. The computer case as claimed in claim 7, wherein the four connecting elements are fixed on the resisting surface by fasteners.

9. The computer case as claimed in claim 7, wherein the connecting elements are rectangular sheet structures.

10. The computer case as claimed in claim 1, wherein the brackets are rectangular sheet structures.

11. The computer case as claimed in claim 1, wherein each latching portion has a wedge surface.

12. The computer case as claimed in claim 1, wherein the two latching elements are plastic.

13. The computer case as claimed in claim 1, wherein each bracket comprises a bracket surface for contacting a corresponding resisting surface and a bracket sidewall perpendicular to the bracket surface, the pinhole is defined in the bracket sidewall.
